(19) United States
(12) Patent Application Publication
(10) Pub. No.: US 2002/0188469 A1
(43) Pub. Date: Dec. 12, 2002

(54) Pharmaceutical distribution and sales method

(76) Inventors: Michael Shalmi, Hellerup (DK); Michael J. Dwyer, Hillsborough, NJ (US)

Correspondence Address: STROOCK & STROOCK & LAVAN LLP, 180 Maiden Lane, New York, NY, 10038, US

(21) Appl. No.: 10/104,087

(22) Filed: Mar. 21, 2002

Related U.S. Application Data
(60) Provisional application No. 60/277,467, filed on Mar. 21, 2001.

(51) Int. Cl. G06F 17/60

(52) U.S. Cl. 705/2

(57) ABSTRACT

The present method provides a pharmaceutical distribution and sales method and system by which a manufacturer of a drug contracts with a customer to supply a certain quantity of the drug based on potential patient use, stocks the customer with the contractual quantity of drug, and charges the customer a predetermined cost, regardless of the quantity of drug that may actually be needed or used. This system minimizes the financial risk for customers purchasing these costly drugs and at the same time ensures an adequate supply of drug for patients when they need it.

### CROSS-REFERENCE TO RELATED APPLICATIONS

This application claims priority to provisional Patent Application Serial No. 60/277,467, entitled, “Pharmaceutical Distribution and Sales Method,” filed on Mar. 21, 2001.

### FIELD OF THE INVENTION

The present invention relates generally to a method of distributing pharmaceuticals, drugs or other medicament compounds, and in particular, to a sales and distribution method for ensuring that hospitals, pharmacies, clinics, doctors or other providers have sufficient on-hand availability of certain selected medicines, particularly when such medicines are life-saving compounds, at a more predictable cost than heretofore contemplated. As hemostatic agents are exemplary, a hemostasis management system is also presented.

### BACKGROUND OF THE INVENTION

There are many diseases and conditions today that require treatment with drugs of either high cost, short supply or limited shelf life, or all or a combination of such factors or other factors that make distribution, stockpiling, and costs difficult to manage at the manufacturer, health care provider, pharmacy or patient level. One exemplary condition is bleeding disorders.

Uncontrolled and excessive bleeding is a major problem both in connection with surgery and also various forms of tissue damage. Bleeding disorders may be caused by clotting factor deficiencies or clotting factor inhibitors (Hemophilia A and B). Bleeding disorders are, however, also seen in patients not suffering from Hemophilia A or B, for example, in patients suffering from von Willebrand's disease. Patients with von Willebrand's disease have a defective primary hemostasis because they lack or have an abnormal von Willebrand factor protein. Bleeding disorders are also seen in patients with a normally functioning blood clotting cascade and may be caused by a defective platelet function, thrombocytopenia, or even by unknown reasons.

Hemophilia A is a rare, hereditary, gender-linked bleeding disorder caused by the absence or deficiency of the blood clotting protein Factor VIII. As a result of this deficiency, the patient may experience spontaneous internal bleeding, which can lead to serious sequelae such as destruction of joints or atrophy of limbs. Life-threatening episodes such as intracranial hemorrhages may also occur.

Hemophilia B, less common than Hemophilia A, is a gender-linked bleeding disorder caused by the absence or deficiency of the blood clotting protein Factor IX. Clinical presentation of Hemophilia B is nearly identical to that of Hemophilia A.

The standard treatment for moderate to severe Hemophilia A or B in the prevention and/or treatment of bleeding episodes is lifelong replacement therapy with Factor VIII or Factor IX. Approximately 15% of Hemophilia A or B patients, however, develop inhibitors (antibodies) to Factor VIII or IX, rendering this treatment ineffective. In some cases inhibitor development also occurs in patients without Congenital hemophilia (acquired hemophilia).

Factor VIIa, such as NovoSeven® (Recombinant Coagulation Factor VIIa), overcomes this problem by enabling clotting through a unique mechanism of action that induces hemostasis independently of Factor VIII or IX. (U.S. Pat. No. 4,382,083). When complexed with tissue factor, Factor VIIa can activate Factor X to Factor Xa, as well as Factor IX to Factor IXa. Factor Xa, in complex with other factors, then converts prothrombin to thrombin, which leads to the formation of a hemostatic plug by converting fibrinogen to fibrin and thereby inducing local hemostasis. Thus, for patients, with inhibitors to Factor VIII or Factor IX, treatment with Factor VIIa is both effective and reliable.

Patients with von Willebrand's disease have a defective primary hemostasis because they either lack or have an abnormal von Willebrand factor protein. Patients with von Willebrand's disease consequently have mucosal bleedings both from the nasal-oral area and the gastrointestinal tract. Those having the most severe forms of von Willebrand's disease also suffer from joint bleedings. Individuals with von Willebrand's disease can therefore benefit from treatment with Factor VIIa (U.S. Pat. Nos. 4,784,950 and 5,180,583).

Thrombocytopenia, defined as “a decreased number of circulating platelets,” is a common clinical problem associated with a diverse group of diseases and complex situations in which multiple factors contribute to the low platelet count. Lowered platelet counts result in an increased bleeding tendency manifesting itself in mucosal bleedings from, for example, the nasal-oral area or the gastrointestinal tract, as well as in oozing from wounds, ulcers and injection sites. Thrombocytopenic bleeding can be extensive and create serious problems both during surgery and also postoperatively. Even minor surgery such as a tooth extraction may cause severe bleeding. Furthermore, spontaneous intracranial bleeding may occur at extremely low platelet counts (<10×10⁹/1).

Patients with thrombocytopenia are commonly treated by the administration of platelet concentrates prepared from donor blood. Such concentrates consist of pooled platelets from 5-6 donors. Most repeating recipients of platelet transfusions, however, develop antibodies against platelet antigens, resulting in a poor or totally absent effect of further platelet transfusions. Factor VIIa has been shown to be effective in treating patients with thrombocytopenia (U.S. Pat. No. 5,180,583).

A defective platelet function is rather common both as a congenital disorder (Glanzmann's thrombastenia, other congenital forms of thrombastenia, platelet aggregation defects) and as a complication to a number of diseases such as leukemia, dysproteinemia (e.g., myeloma), autoimmune diseases (e.g., rheumatoid arthritis, systemic lupus erythematosus) and uremia. Patients with a defective platelet function may develop bleedings mostly of a mucosal type, as described above for patients with thrombocytopenia. Consequently, patients with a defective platelet function can also benefit from treatment with Factor VIIa (U.S. Pat. No. 5,180,583).

Treatment with hemostatic agents such as Factor VIIa, Factor VIII or Factor IX, however, presents a challenge for the manufacturer and customer alike. This is because a bleeding cannot be predicted but is a stochastic event in its three primary variables: frequency, severity and duration. Thus, the customer, e.g., the hospital, pharmacy, health care provider, clinic or the like, cannot know beforehand the quantity of hemostatic agent it will need for each specific patient. Likewise, the manufacturer's sales representatives are unable to accurately forecast how much drug should be stocked at various distribution centers, and the manufacturer is uncertain as to how much product it should produce. These aforementioned factors, among others, can lead to chronically short supplies of needed drugs and/or to excess stock capacity in other centers, due in whole or in part to an inability to obtain proper predictions of requirements when a bleed is ongoing.

Moreover, treatment with certain drugs, such as for example hemostatic agents, are very costly, which also influences the quantity of drug a customer is willing to stock, and hence, the quantity a manufacturer will produce.

In one exemplary instance, a company was unable to manufacture enough of its new drug. The company announced that potential patients would have to apply and be approved to receive the product directly from the company, as the product would not be made available through pharmacies or other distributors. The company stated that it did not want extra inventory of the drug held at pharmacies when the drug was in short supply. Certain patient advocacy groups protested the distribution plan, claiming it would exclude uninsured patients, make the product unavailable to hospitals for emergencies, and help limit supply, thereby keeping prices up.

Therapy for certain life threatening maladies such as hemophilia can be costly, in some cases greater than $100,000 per year in year 2000 dollars, depending on the weight of the patient and the treatment plan, e.g., primary prophylaxis vs. secondary vs. episodic therapy vs. emergent or routine.

As an example, the recommended dosage of NovoSeven is 90 μg/kg given every two hours until hemostasis is achieved. The average inhibitor patient has 10 bleeds per year which, for a person weighing 50 kg (110 lbs.), would in year 2000 dollars cost over $100,000 per year. For a trauma patient experiencing extensive bleeding, the cost could be considerably higher if the underlying cause is an acquired (non-hemophilic) inhibitor status, or it could be lower if bleeding is characterized primarily by simple oozing. Moreover, a critical issue in providing a potentially life saving hemostatic treatment is that this cannot be stopped once it has been embarked upon. Thus for some patients who require protracted treatment either due to a major bleeding or in whom effective hemostatic treatment is initiated late following onset of the bleeding condition, the pharmaceutical treatment cost associated with the single bleeding episode may actually exceed a full years' treatment cost. This is a serious problem for manufacturers of costly but yet effective hemostatics, since the single high treatment episode deters physicians from initiating this treatment. There is consequently a significant need to offset this negative outcome by ensuring an early intervention in all patients with fully effective treatments and to limit the financial exposure the physicians undertake in doing so.

Since 1995, the demand for such drugs as for example recombinant Factor VIII has nearly doubled on a global basis. The heightened demand is due to numerous factors, including increased use to prevent bleeding, rather than treating patients only when bleeds occur (The Regulatory News Service, Oct. 5, 2000). As the use for Factor VIIa and other such life saving drugs expands, the population and need for this drug will also increase.

Since the demand for hemostatic agents continues to rise, the demand for Factor VII, VIII and/or IX is potentially exceeding the available supply, and these drugs may be too costly for customers to stock more than a minimum supply. There is thus an unsolved need for a method and system that will minimize the financial risk for customers purchasing the drug, and at the same time ensure an adequate supply of the drug for patients when they need it.

### SUMMARY OF THE INVENTION

The present invention meets the heretofore unmet need in the art, as well as others which will become apparent to those skilled in the art from the disclosure set forth herein, by providing a method that converts the treatment cost for drugs from a variable cost per unit, e.g. mg or μg, to a generally fixed cost per patient, thereby minimizing the financial risk of the customer and ensuring a readily available supply of drug for patients when needed.

More specifically, the present invention is directed to a method of providing a hemostasis management system, comprising the steps of contracting with a customer to provide a quantity of a hemostatic agent for administration to a predetermined universe of patients based on predicted per patient use, providing the customer with the contractual quantity of the hemostatic agent, charging the customer a fixed fee per patient in the universe who potentially requires the hemostatic agent regardless of the quantity of agent actually required by the universe of patients during the time period, and, providing and delivering a replenishment amount if the on-hand amount at the contractor falls below a certain limit. The method also provides for delivery of a quantity of hemostatic agent sufficient to satisfy the contractual quantity within a predetermined time of receiving notice from the customer that such replenishment is needed, or tracking the on-hand amount at the customer and automatically providing and delivering the replenishment amount, thereby ensuring a readily available supply of hemostatic agent when needed.

Also contemplated is a method of supplying a drug, comprising the steps of identifying a customer of the drug, determining a quantity of the drug to be delivered to the customer over a time period, determining a cost to be charged to the customer for the drug in the quantity over the time period, reaching an agreement with the customer to provide the drug to said customer in the quantity at the cost over the time period, and reaching, as an incentive to reaching the aforementioned agreement, a further agreement with the customer to provide an additional quantity of the drug to the customer at no additional cost if such additional quantity is needed by the customer within the time period.

Also contemplated is a method of delivering a drug to a customer, comprising the steps of: (a) contracting with a customer over a time period to provide a quantity of a drug for use by a universe of patients served by the customer based on a predicted per patient use; (b) charging the customer a fixed fee per patient in the universe; and (c) providing the customer with at least the quantity of the drug regardless of the quantity of drug actually required by the customer during the contract period, thereby ensuring a readily available supply of the drug, when needed, at a predictable cost. The method further provides that the universe of patients comprises the patients known by the customer to potentially require the drug. The predicted per patient use is an estimate of a patient's potential need for the drug and is determined based on plural factors which include the type of customer, the types of services provided the customer, the number of patients served by the customer and demographic data related to the patients served by the customer. If the customer is a hospital, a non-exhaustive list of plural factors include the number of patients registered at the hospital, the number of beds in the hospital, the number of admissions in a previous time period, the number of units of drug used over a time period and the types of procedures most often performed by the customer.

Also contemplated is a method of securing immediate treatment for a patient experiencing a bleeding at a hospital, the method comprising the steps of (a) contracting with a hospital to provide a certain quantity of Factor VIIa based on potential patient use; (b) stocking the hospital with the contractual quantity of Factor VIIa; and (c) charging the hospital a fixed fee per patient who potentially requires Factor VIIa regardless of the quantity actually used, thereby ensuring a readily available supply of Factor VII and securing immediate treatment for the patient experiencing the bleeding.

Also contemplated is a method of securing immediate treatment for a patient experiencing a bleeding at a hospital, the method comprising the steps of: (a) contracting with a hospital to provide a quantity of a hemostatic agent based on potential patient use; (b) stocking the hospital with the contractual quantity of the hemostatic agent; and (c) charging the hospital a fixed fee per patient who potentially requires the hemostatic agent regardless of the quantity actually used, thereby ensuring a readily available supply of the hemostatic agent and securing immediate treatment for the patient experiencing the bleeding.

The hemostatic agent is plasma-derived or recombinant. The hemostatic agent could be Factor VIIa, Factor VIII or Factor IX. The customer could be a patient, doctor, pharmacy, hospital, clinic, home health care company, insurance company or national health authority.

Other objects and features of the present invention will become apparent from the following detailed description, considered in conjunction with the accompanying drawing figures. It is to be understood, however, that the drawings, which are not to scale, are designed solely for the purpose of illustration and not as a definition of the limits of the invention, for which reference should be made to the appended claims.

### DESCRIPTION OF THE DRAWING FIGURES

In the drawing figures, which are not to scale, and which are merely illustrative:

FIG. 1 is an exemplary representation of the possible relationships between the manufacturer, suppliers, and patients/users of a drug;

FIG. 2 is an exemplary graphical representation of a cost curve depicting an aspect of he present invention; and

FIG. 3 is an exemplary schematic of a system of the type that can be used to implement an embodiment of the present invention.

### DETAILED DESCRIPTION OF THE INVENTION

Throughout the specification, the following terms have the indicated meaning:

The term “customer” means any entity that purchases the drug or hemostatic agent, such as, for example, patients, doctors, pharmacies, hospitals, clinics, home health care companies, insurance companies and national health authorities. The purchase may be made directly from the manufacturer or through a representative of the manufacturer, such as a distributor or sales agent.

The term “hemostatic agent” means any agent that arrests the flow of blood from an open vessel. The hemostatic agent may be either plasma-derived or recombinant. Thus, the term may include, for example, Factor VIIa (such as NovoSeven®), Factor VIII (such as Refacto®, Kogenate FS®, Helixate FS®, Recombinate™ and Bioclate®), and Factor IX (such as BeneFIX®).

The term “drug” means (a) articles recognized in the official United States Pharmacopoeia, official Homeopathic Pharmacopoeia of the United States, or official National Formulary, or any supplement to any of them, (b) articles intended for use in the diagnosis, cure, mitigation, treatment, or prevention of disease, (c) articles (other than food) intended to affect the structure or any function of the body, and (d) articles intended for use as a component of any article specified in clause (a), (b) or (c), and any other meaning attributed to the term “drug” by any future modification of the Federal Food, Drug and Cosmetic Act. For example, a drug can be a device; a drug can also be a hemostatic agent as defined herein.

In one preferred aspect, the present invention is directed to a method of drug delivery comprising the steps of:

(a) contracting with a customer to provide a quantity of a drug for use by a universe of patients based on predicted per patient use;

(b) providing the customer with the quantity of the drug; and

(c) charging the customer a fixed fee per patient in the universe of patients who potentially require the drug regardless of the quantity of the drug actually used,

thereby ensuring a readily available supply of the drug when needed, and providing the customer with a predictable cost for this delivery regardless of potential additional usage.

The method further comprises the steps of providing and delivering a replenishment amount of the drug when it falls below a certain limit, wherein a replenishment amount of the drug sufficient to satisfy the contractual quantity is delivered within a predetermined time of receiving notice from the customer that such replenishment is needed. The method further comprises the steps of tracking the customer's on-hand amount and automatically providing the replenishment amount.

In another aspect, the present invention is directed to a method of securing immediate treatment for a patient experiencing a bleeding at a hospital, the method comprising the steps of:

(a) contracting with a hospital to provide a certain quantity of a hemostatic agent based on potential patient use;

(b) stocking the hospital with the contractual quantity of the hemostatic agent; and

(c) charging the hospital a fixed fee per patient who potentially requires the hemostatic agent regardless of the quantity actually used,

thereby ensuring a readily available supply of the hemostatic agent and securing immediate treatment for the patient experiencing the bleeding, and providing the customer with a predictable cost for this delivery regardless of potential additional usage.

This method further comprises the step of replenishing the stock when it falls below a certain limit, wherein a quantity of hemostatic agent sufficient to satisfy the contractual quantity is delivered within a predetermined time of receiving notice from the customer that such replenishment is needed.

Using the present sales method, the drug is, from a customer perspective, converted from a product that is purchased to a service provided by the manufacturer. Using the present sales method, the manufacturer's sales representatives can shift a part of their sales focus from a quantity based focus, e.g., mg or μg of drug sold, to the development of service contracts that cover a group of patients (e.g., inhibitor patients in home treatment; trauma patients received in the ER; all the patients in a hospital) and provide those patients with the drug in exchange for a fixed payment per patient which is paid by the customer. This system has several advantages that will be presented herein below and others that will be recognized by the skilled practitioner utilizing the teachings herein.

By way of non-limiting example, the inventive method will be described in connection with a particular drug, i.e., a particular hemostatic agent such as NovoSeven. Sometimes, NovoSeven is not used as a first line treatment and may not even be listed as an option because such treatment is perceived to be very costly. And because the variable cost associated with NovoSeven usage often comes from a particular department's budget at a treating hospital or clinic, single patients running up huge NovoSeven costs will seriously drain that budget. In contrast, the capacity cost associated with managing a bleeding is taken care of by the hospitals. Thus, by converting NovoSeven treatment cost from a variable product cost to a fixed patient cost, the expense is integrated into the hospital budgets and removed from the treating physicians' considerations.

More than 90% of all hemophilia bleedings treated in the home are covered by a few injections of a hemostatic agent, whereas a small percentage will demand continued administration due to the late onset of treatment or the severity of the bleed. As a result, many treatment centers experience single patient bleeds costing, in year 2000 dollars, about $125,000 every year. This creates a barrier to further treatment. Thus, by providing a hemostasis management system in which the cost per patient is fixed, each center can determine, based on review of the number of patients and their body weight (since most coagulant factors are dosed by weight), what its yearly treatment costs will be, and therefore, budget accordingly.

The present invention offers a reduced risk financial solution in hemostasis management. As no one can predict with certainty when a bleeding will occur, or whether a bleeding will be mild, moderate or severe, it is more likely that a customer will choose to be provided product through a fixed payment per patient contract, thereby securing sufficient availability of product in all treatment locations and eliminating local shortages.

For example, if a hospital has 10,000 patients passing through its wards per month, the hospital could enter into a low cost service contract on behalf of these patients (since the individual does not know when he or she will end up in a hospital). Alternatively, if 2,000 of these patients pass through high-risk wards of bleeding (e.g., ICU, Emergency, Operations), a somewhat higher cost should be expected. If the hospital has, for example, 500 medical emergencies, 200 surgeries and 100 casualties on a monthly basis, the contracted cost could be calculated on this basis.

The service contract may also include a provision requiring the manufacturer or a site controlled by the manufacturer to replenish the drug supply when it falls below a certain limit, wherein a replenishment amount of hemostatic agent sufficient to satisfy the quantity is delivered within a predetermined time of receiving notice from the customer that such replenishment is needed. The customer may notify the manufacturer by phone, fax or by computer via the Internet. Alternatively, the manufacturer can set up a customer account to track the on-hand amount in the customer's inventory or in any way that the customer maintains such amount such that when the on-hand amount falls below the limit agreed upon, a shipment of a predetermined replenishment amount of drug will automatically be delivered to the customer. Either method will minimize the likelihood that a severe product need, such as due to the simultaneous treatment of multiple patients, will result in a temporary shortage of the drug.

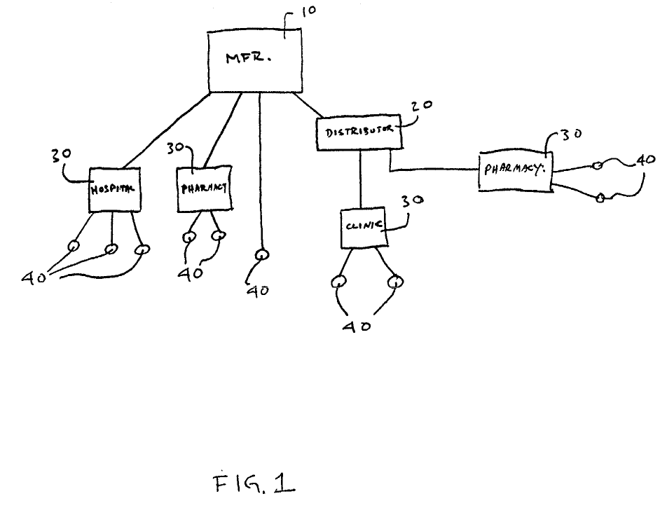

Referring now to the drawing FIGS. 1-3, and with initial reference to FIG. 1, there is shown an illustrative representation of the various relationships that might exist between a manufacturer 10 of a drug and the various customers 30 of that manufacturer that either purchase, warehouse, distribute and/or use the drug being sold by the manufacturer. The method and system of the present invention might be utilized by a manufacturer 10 in contracting with a hospital 30, which hospital 30 in turn would provide the needed drug to patients 40. Alternatively, the manufacturer 10 could utilize the system and method of the present invention to manage its relationship with pharmacy 30, which pharmacy 30 in turn distributes the manufacturer's drug to patients 40. Alternatively, the manufacturer 10 could utilize the methodology of the present invention to deal directly with a user of the drug 40.

A manufacturer 10 might also implement the present invention in connection with its relationship with a distributor 20. That distributor 20 might in turn utilize the present invention to manage its relationship with customers of the distributor, such as a clinic 30 or a pharmacy 30, each of which in turn supply the drug to patients or users 40. Thus, in connection with FIG. 1, which is exemplary, a hospital, pharmacy or clinic identified as reference number 30 is a customer of the manufacturer while a distributor 20 is also a customer of the manufacturer. On the other hand, a clinic or pharmacy 30 that obtains the drug from distributor 20 is a customer of the distributor. In turn, the patients or users 40 that obtain the drug from a hospital or pharmacy or clinic are the ultimate end users of the drug.

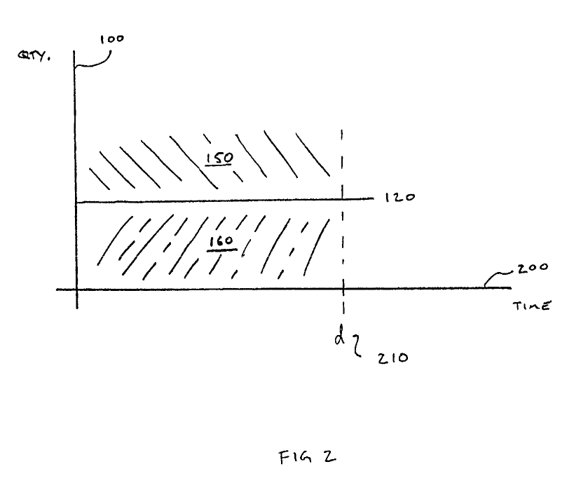

With reference to FIG. 2, there is depicted an illustrative graph illustrating conceptually a preferred embodiment of the present invention. Preferably the method of the present invention is depicted in the context of creating a contractual relationship between a manufacturer and a customer or between a distributor and a customer or between a customer and a user, wherein the relationship consists of an agreement to purchase a fixed quantity of a drug over lime at a contracted for cost. With reference to FIG. 2, the quantity axis 100 and time axis 200 are depicted to illustrate a contract having a time duration d, 210, and a quantity to be supplied over time duration d illustrated by line 120. Assuming for the sake of example, that a manufacturer enters into a contract with a customer to supply a drug of a uniform quantity 120 for a time duration 210, the area under line 120 and bound by time duration d, 210, is represented by hatched area 160, which represents the total quantity of drug that would be supplied for the length of the contract. The region 150 represents the region in which the manufacturer will supply more than the fixed quantity, and is the zone of risk to the manufacturer where it may be supplying the drug at no cost or a lower than desired cost.

So long as the total quantity of drug supplied over the course of the duration of the contract does not exceed the total quantity contracted for, the manufacturer cannot be in the position of having supplied more drug than it was paid for. On the other hand, should the quantity required by the customer exceed the total quantity contracted for, then nonetheless the manufacturer would supply that additional quantity required, as also required in the contract, and the manufacturer would on a per unit basis receive less compensation for the drug that has been contracted for. The advantage to a customer of entering into a fixed duration contract having a fixed price and an estimated quantity that might be exceeded at no additional cost to the customer is that the customer's risk of overly high use will be mitigated. Thus, while the manufacturer may require the customer to purchase or commit to a quantity more than that customer might have been willing to in the past, this greater quantity or price would be justified should the customer's needs exceed its forecasted quantities.

On the other hand, the manufacturer has incentives to enter into such contracts since a manufacturer can better estimate quantities over a period of time and thus realize manufacturing efficiencies and also plan ahead to compensate for such factors as shelf life and/or likely difficulties that might be encountered in the supply chain. Thus, the manufacturer is willing to accept the risk of overuse in exchange for potential greater certainty in manufacturing quantities, improved manufacturing cost efficiencies and/or improved revenue predictability.

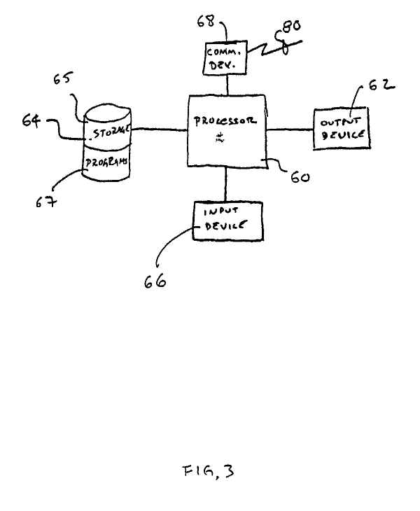

With reference to FIG. 3, the system and method of the present invention can be implemented in software in a programming language known in the art utilizing a computer of any type now known in the art or hereafter become known. Specifically, the system and method of the present invention can be programmed on a computer having a processor 60 that has the ability to process and execute commands and data residing in software and the matter known in the art. Processor 60 preferably has a human interface whereby an operator can interact with the system, in the form of an input device 66 which may be a keyboard, mouse, light pen or any other known input device for entering information into the computer. Also preferably included is an output device 62 for allowing the results of any processing to be displayed in some user perceptible form, such as a display screen or printer or combination thereof. Also preferably included is a communication device 68 for connecting the processor 60 to a communication line 80. Communication device 68 may be any type of communication interface for connecting processor 60 to a local area network, wide area network, the internet, a telephone or telecommunications facility, or any other means now known or hereinafter to become known for facilitating communication between different computer systems. Also preferably included is a computer-readable storage medium 64 that may store program data 65 as well as stored programs 67 which can be executed by processor 60 to carry out at least some of the methodology of the present invention and other application specific programs as a matter of design choice.

In its simplest form, the method and system of the present invention may be implemented by a manufacturer identifying a customer that is a purchaser of a specific drug. The manufacturer would likely use plural factors, including historical information, to provide an idea of the customer's consumption of the drug over a desired period of time. Additionally, it is likely that the customer would also use plural factors, including historic data indicative of its prior use of the drug over defined time periods, to determine its needs.

The manufacturer, in an effort to improve its manufacturing efficiencies and revenue predictability, would approach the customer to enter into an agreement or contract to purchase a specific quantity of the drug over a specific period of time at a specific price; the manufacturer would determine these variables using plural factors. The time duration can be measured in months, quarters, years or any other suitable time unit depending on the circumstances of the relationship and other variables specific to the relationship between the manufacturer and that customer. The manufacturer would seek to make the contacted-for quantity most closely match the manufacturer's estimate of the likely requirement of that customer over the period to be contracted for.

The customer on the other hand, desires to pay for no more than the drug that it needs. Although in most instances the customer is aware of the risk that in times of high or unexpected demand, the price and availability of the drug could be such that the customer would be unwilling to or unable to pay for or obtain the drug. Thus, in an effort to mitigate this instance, the manufacturer and customer would seek to arrive at a quantity that provides some degree of certainty to the customer that it would not be overpaying for a drug that it does not need, but yet would be assured that it has a ready supply of all of the drug that it needs if its requirements should change unpredictably.

Thus, the manufacturer would enter into a contract with the customer to provide a specific quantity of drug over a specific period of time for a specific quantity. In the event that the customer's requirements exceed the contracted-for quantity, the manufacturer would nonetheless agree to provide that additional required quantity at no cost, at a greatly reduced cost or at some other cost factor suitable to the manufacturer's requirements. Thus, by way of example, assume that a manufacturer enters into an agreement to supply a customer with one thousand units of a drug over the course of one year for one thousand dollars. The manufacturer is now assured that this customer will be paying one thousand dollars and will be agreeing to take from that manufacturer and inventory one thousand units of the drug. Thus, the manufacturer has a predictable income stream and predictable manufacturing requirement. Should, however, the customer require greater than one thousand units over the one year period, the manufacturer would agree to provide those units to the customer at no additional cost. This additional commitment is what provides the incentive for the customer to commit to paying a fixed quantity for a fixed quantity that may have been greater than a quantity that the customer would have been willing to keep on hand as inventory had the manufacturer's agreement to commit to the oversupply not been present. Thus, both the manufacturer and customer have the potential benefits through predictability and also similar risks through uncertainty. Specifically, at the end of the contracted-for period, and referring to the previous example, if the manufacturer had to supply one thousand five hundred units of the drug over the course of the period, then the manufacturers profit would be less. On the other hand, if the hospital only utilized eight hundred units of drug, it would have overpaid. Thus, each of the manufacturer and customer will seek to employ the most accurate forecasting possible to reach an agreement that is potentially beneficial to both, with the risks properly allocated.

Plural factors that might be considered by a manufacturer, customer, or both include the type of customer, the types of services provided by the customer, the number of patients served by the customer, and demographic data related to the patients served by the customer.

By way of example, if the drug is a hemostatic agent, then the plural factors that might be considered by a manufacturer or customer or both, in the instance where the customer is a hospital, might be such variables as the number of beds in the hospital, and the type of hospital. Specifically, if the hospital has many operating rooms it may be expected to require more hemostatic agent over the course of a year than another hospital with fewer operating rooms.

Another factor to be considered is whether the hospital is a trauma center, in which case the expectation of high use would also be great. Other plural factors that may prove useful to both the customer and manufacturer in determining the contracted-for quantities and duration would be the number of emergency room visits experienced by the hospital over some prior time period, the number of admissions to the hospital in a previous time period, the number of units of drug that were used by the hospital over some prior time period, and other such factors. Additionally, the manufacturer and/or customer can perform a statistical analysis on the hospital's patient records to obtain an indication of what types of procedures are most often performed at the hospital, such as, by examining records of the ICD 9 codes that are contained in the hospital's patient record system so that an analysis of procedural uses might be performed.

In other instances, a customer might be a designated center for the treatment of hemophiliacs in which case, it would be expected that the need for hemostatic agents would be greatly increased over a different customer without a hemophilic population of patients. Thus, if the customer is a hemophilia treatment center, the number of hemophilic patients as well as the historic use data of these patients would also likely be factors to be considered by the manufacturer and/or customer in reaching a decision on contracted-for quantities, price and duration.

The method and system of the present invention are flexible in that the quantities, time durations, and prices charged can be flexibly administered to accommodate the wide variety of needs of the customers of different types and patient populations of different types.

Of concern to a manufacturer of a drug might be, for example, the possibility that a customer, knowing that it will be supplied with additional quantities even beyond its contracted-for quantities and prices, will begin to use the drug in ways, quantities, or for uses which were not previously anticipated by the manufacturer. Thus a manufacturer might, as part of the agreement, dictate that the contracted-for drug may be used for only limited uses or for a target patient population or for exclusive use in a trauma center or some other manufacturer recognized limit so that the use does not expand artificially once the contract with the customer has been entered into.

As an additional incentive to enter into a contract and/or as an additional benefit to the manufacturer in offering such contracts, the customer can be asked to agree to supply patient data or patient use data so that the manufacturer's demographic database will be improved. Such patient and/or patient use data can provide a significant source of information to the manufacturer in determining where best to deploy its resources in supplying the drug, what customer populations are particularly well suited to employ the system and method of the present invention, what trends the manufacturer might expect in usage in various parts of the geographic area governed by the contract, as well as many other uses that a person of skill, utilizing the teachings herein, would recognize as applicable to having improved demographic patient and/or patient use data.

Another embodiment of the system and method of the present invention contemplates that the contracted-for quantities, price and/or duration could be stepped in increments so as to mitigate the risk to the manufacturer that any particular customer's use will so exceed expectations as to create difficulty for the manufacturer. Thus, one way that a manufacturer could structure an agreement with a customer would be to agree to a fixed quantity at a fixed price for a fixed duration, and agree to provide additional drug beyond the contracted-for quantity or quantity at no additional cost until a second benchmark quantity is reached, after which the customer will pay at a new rate, presumably a reduced rate or flexible rate thereafter.

Another option that might be considered in deploying a system and method of the present invention is to provide for a contract that has a fixed duration, such as, for example two years. This two-year period is further divided into six month sub-periods. The manufacturer would agree to provide a certain quantity of the drug at a certain price during the first sub-period, and agree to provide additional amounts beyond the contracted-for quantities at no additional cost during the first sub-period. At the end of the first sub-period, the actual usage is analyzed by the manufacturer to determine what the contracted-for price and quantity would be for the next sub-period. At the end of the next sub-period, the same analysis is performed, thus neither the customer nor the manufacturer are at risk for the entire two-year duration, since the six month sub-period adjustment is available to fine tune the requirements of both the manufacturer and the customer.

In addition to the customer and patient variables described above, other variables that might be taken into account by a manufacturer and/or customer and/or patient in utilizing the system and method of the present invention are such factors as what if any impact government payment limits, third party payer options, government regulation or external contract limitations might have on the contemplated agreement. For example, the level of reimbursement that a third party payer might be willing to extend to a customer would impact the quantities that a customer would be willing to commit to with a manufacturer. Thus, it is contemplated within the scope of the present invention that the variables identified above, plus other variables now known or hereinafter to become known by the person of skill can be factored into the analysis performed by the manufacturer/customer and/or patient in arriving at the quantities, price, and duration of any agreement in such a manner as to fine tune the risk to any of the parties to within acceptable limits, as a matter of application specific design choice. Thus, the manufacturer and/or customer can agree to limits on the side of the manufacturer to some absolute maximum to be supplied, if usage becomes so extraordinary as to be unforeseen by either party. By the same token, should the customer's demand fall so far below estimated that the customer is faced with much a higher than expected contracted-for cost per user, a return or reimbursement program could be considered by the manufacturer.

Other considerations that could be factored in to the system and method of the present invention could be when payment occurs, such as, for example, full payment at the commencement of the time period, uniform payments distributed over the course of the contracted-for time period, or periodic payments at an agreed quantity over the course of the contracted-for time period. Likewise for shipment, the contract can provide for shipping the entire contracted-for quantity at the beginning of the contracted-for time period, or shipping a uniform quantity over predefined time sub-periods, in a way to maximize the shelf life of the supply at the customer location.

Additionally, in those circumstances where the contract calls for sub-periods within which the quantities and usage are reanalyzed, certain triggering events such as natural disasters or accidents that would cause high need could trigger modifications in the agreement or accelerate the recalculation of price and/or quantity to accommodate these extraordinary circumstances.

Moreover, while it is contemplated that the system and method be in whole or in part implemented on a computing device, it is possible to practice the system and method of the present invention in purely manual terms. Alternatively, a mix of automated and manual methods might be incorporated. In the event that the system and method is implemented in a software program, it is contemplated that the software program would run over any computer now known or hereinafter to be known, either in a single processor, distributed processor, or networked system topography. Moreover, while the usage of the system and method of the present invention in relation to hemostatic agents is indicated as preferred, the system and method of the present invention is not limited to use and connection solely with hemostatic agents, but any drug or product where the manufacturer and consumer willing to employ the system and method of the present invention to improve predictability of supply and costs and mitigate risks associated with market uncertainties.

It should be understood that the foregoing description is considered in all respects to be illustrative and not restrictive. The scope of the invention is indicated by the appended claims, and all changes which come within the meaning and range of equivalents thereof are intended to be embraced therein.

We claim:

1. A method of providing a drug to a customer, the method comprising the steps of:
a. identifying a customer of the drug;
b. determining a quantity of the drug to be delivered to the customer over a time period;
c. determining a cost to be charged to the customer for the drug in the quantity over the time period;
d. reaching an agreement with the customer to provide the drug to the customer in the quantity at the cost over the time period; and
e. as an incentive to reaching the aforementioned agreement, reaching a further agreement with the customer to provide an additional amount of the drug to the customer at no additional cost if the additional amount is needed by the customer within the time period.

2. The method of claim 1, wherein the drug is selected from a group consisting of:
articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

3. The method of claim 1, wherein the customer is any entity that purchases the drug.

4. The method of claim 1, wherein the customer is an entity selected from a group consisting of: doctors, pharmacies, hospitals, clinics, home health care companies, insurance companies and national health authorities.

5. The method of claim 1, wherein the quantity is determined based on plural factors.

6. The method of claim 5, wherein at least one of the plural factors is drawn from the group of factors consisting of: the type of customer, the types of services provided by the customer, the number of patients served by the customer, and demographic data related to the patients served by the customer.

7. The method of claim 4, wherein the customer is a hospital.

8. The method of claim 7, wherein the quantity is determined based on plural factors.

9. The method of claim 8, wherein at least one of the plural factors is drawn from the group of factors consisting of: the number of beds in the hospital, the number of emergency room visits over a prior time period, the number of admissions in a previous time period, the number of units of drug used over a time period, and the types of procedures most often performed by the customer.

10. The method of claim 1, wherein the quantity is fixed over the time period.

11. The method of claim 1, wherein the time period is fixed.

12. The method of claim 1, wherein the cost is fixed over the time period.

13. The method of claim 1, further comprising providing a replenishment amount of the drug to the customer should an on-hand amount at the customer fall below a predetermined limit during the time period.

14. The method of claim 13, further comprising delivering the replenishment amount within a predetermined time period of receiving notice from the customer that the on-hand amount has fallen below the predetermined limit during the time period.

15. The method of claim 13, wherein the on-hand amount at the customer is tracked and the quantity is automatically replenished should the quantity fall below a predetermined limit during the time period.

16. The method of claim 1, wherein the quantity is fixed for a duration of a first time period portion, and altered at the expiration of the first time period portion for a duration of a second time period portion.

17. The method of claim 1, wherein the time period comprises increments of time, wherein at the end of each increment of time, the quantity and/or cost is adjusted to mitigate financial risk.

18. The method of claim 17, wherein triggering events trigger modifications in the agreement to accommodate extraordinary circumstances.

19. The method of claim 18, wherein the triggering events are incidents that cause unexpectedly high need for the customer.

20. The method of claim 1, wherein the cost is fixed for the time period, then altered at the expiration of the time period for a duration of a new time period.

21. The method of claim 1, wherein the additional amount is limited if the needs of the customer exceed a predetermined upper need threshold.

22. The method of claim 1, wherein the cost is limited if the needs of the customer fail to reach a predetermined lower need threshold.

23. The method of claim 1, further comprising structuring the agreement so as to dictate that the drug is to be used for a predetermined use.

24. The method of claim 1, further comprising structuring the agreement so as to dictate that the drug is to be used for a predetermined universe of patients.

25. A processing system comprising an input device, a processor, an output device, a communication device and a computer-readable storage medium comprising a program for performing at least some of the method of claim 1.

26. A method of supplying a drug, the method comprising:
a. contracting with a customer over a time period to provide a quantity of a drug for use by a universe of patients served by the customer based on a predicted per patient use;
b. charging the customer a fixed fee per patient in the universe; and
c. providing the customer with, at least, the quantity of the drug regardless of the quantity of drug actually required by the customer during the time period.

27. The method of claim 26, wherein the drug is selected from a group consisting of: articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

28. The method of claim 26, wherein the customer is any entity that purchases the drug.

29. The method of claim 26, wherein the customer is an entity selected from a group consisting of: doctors, pharmacies, hospitals, clinics, home health care companies, insurance companies and national health authorities.

30. The method of claim 26, wherein the quantity is determined based on plural factors.

31. The method of claim 30, wherein at least one of the plural factors is drawn from the group consisting of: the type of customer, the types of services provided by the customer, the number of patients served by the customer, and demographic data related to the patients served by the customer.

32. The method of claim 29, wherein the customer is a hospital.

33. The method of claim 32, wherein the quantity is determined based on plural factors.

34. The method of claim 33, wherein at least one of the plural factors is drawn from the group of factors consisting of: the number of beds in the hospital, the number of emergency room visits over a prior time period, the number of admissions in a previous time period, the number of units of drug used over a time period, and the types of procedures most often performed by the customer.

35. The method of claim 26, wherein the universe of patients comprises the patients known by the customer to potentially require the drug.

36. The method of claim 26, wherein the predicted per patient use is an estimate of a patient's potential need for the drug.

37. The method of claim 26, wherein the predicted per patient use is determined based on plural factors.

38. The method of claim 37, wherein at least one of the plural factors is drawn from the group of factors consisting of: the type of customer, the types of services provided by the customer, the number of patients served by the customer and demographic data related to the patients served by the customer.

39. The method of claim 29, wherein the customer is a hospital.

40. The method of claim 39, wherein the predicted per patient use is determined based on plural factors.

41. The method of claim 40, wherein at least one of the plural factors is drawn from the group consisting of: the number of patients registered with the hospital, the number of beds in the hospital, the number of admissions in a previous time period, the number of units of drug used over a time period, and the types of procedures most often performed by the customer.

42. The method of claim 26, wherein the quantity is fixed over the time period.

43. The method of claim 26, wherein the time period is fixed.

44. The method of claim 26, wherein the fixed fee per patient in the universe is fixed over the time period.

45. The method of claim 26, further comprising providing a replenishment amount of the drug to the customer should an on-hand amount at the customer fall below a predetermined limit during the time period.

46. The method of claim 45, further comprising delivering the replenishment amount within a predetermined time period of receiving notice from the customer that the on-hand amount has fallen below the predetermined limit during the time period.

47. The method of claim 45, wherein the on-hand amount at the customer is tracked and the quantity is automatically replenished should the quantity fall below a predetermined limit during the time period.

48. The method of claim 26, wherein the quantity is fixed for a duration of a first time period portion, and altered at the expiration of the first time period portion for a duration of a second time period portion.

49. The method of claim 26, wherein the time period comprises increments of time, wherein at the end of each increment of time, the quantity and/or fixed fee per patient in the universe is adjusted to mitigate financial risk.

50. The method of claim 49, wherein triggering events trigger modifications in the agreement to accommodate extraordinary circumstances.

51. The method of claim 50, wherein the triggering events are incidents that cause unexpectedly high need for the customer.

52. The method of claim 26, wherein the fixed fee per patient in the universe is fixed for the time period, then altered at the expiration of the time period for a duration of a new time period.

53. The method of claim 45, wherein the replenishment amount is limited if the needs of the customer exceed a predetermined upper need threshold.

54. The method of claim 26, wherein the fixed fee per patient in the universe is limited if the needs of the customer fail to reach a predetermined lower need threshold.

55. The method of claim 26, further comprising contracting in such a manner so as to dictate that the drug is to be used for a predetermined use.

56. The method of claim 26, further comprising contracting in such a manner so as to dictate that the drug is to be used for a predetermined universe of patients.

57. A processing system comprising an input device, a processor, an output device, a communication device and a computer-readable storage medium comprising a program for performing at least some of the method of claim 26.

58. A method of supplying hemostasis management, the method comprising:
a. contracting with a customer over a time period to provide a quantity of a hemostatic agent for administration to a predetermined universe of patients based on predicted per patient use;
b. providing the customer with the quantity of the hemostatic agent;
c. charging the customer a fixed fee per patient in the universe regardless of the amount of agent actually required by the universe of patients during the time period.

59. The method of claim 58, wherein the hemostatic agent arrests the flow of blood from an open vessel.

60. The method of claim 58, wherein the hemostatic agent is selected from the group consisting of plasma-derived hemostatic agents and recombinant hemostatic agents.

61. The method of claim 58, wherein the hemostatic agent is further selected from the group consisting of Factor VIIa, Factor VIII, and Factor IX.

62. The method of claim 61, wherein Factor VIIa is NovoSeven®.

63. The method of claim 61, wherein Factor VIII is selected from the group consisting of Refacto®, Kogenate FS®, Helixate FS®, Recombinate™ and Bioclate®.k

64. The method of claim 61, wherein Factor IX is BeneFIX®

65. The method of claim 58, wherein the drug is selected from a group consisting of: articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

66. The method of claim 58, wherein the customer is any entity that purchases the drug.

67. The method of claim 58, wherein the customer is an entity selected from a group consisting of: doctors, pharmacies, hospitals, clinics, home health care companies, insurance companies and national health authorities.

68. The method of claim 58, wherein the quantity is determined based on plural factors.

69. The method of claim 68, wherein at least one of the plural factors is drawn from a group of factors consisting of: the type of customer, the types of services provided by the customer, the number of patients served by the customer, and demographic data related to the patients served by the customer.

70. The method of claim 67, wherein the customer is a hospital.

71. The method of claim 70, wherein the quantity is determined based on plural factors.

72. The method of claim 71, wherein at least one of the plural factors is drawn from the group of factors consisting of: the number of beds in the hospital, the number of emergency room visits over a prior time period, the number of admissions in a previous time period, the number of units of drug used over a time period, and the types of procedures most often performed by the customer.

73. The method of claim 58, wherein the universe of patients comprises the patients known by the customer to potentially require the drug.

74. The method of claim 58, wherein the predicted per patient use is an estimate of a patient's potential need for the drug.

75. The method of claim 58, wherein the predicted per patient use is determined based on plural factors.

76. The method of claim 75, wherein at least one of the plural factors is drawn from the group of factors consisting of: the type of customer, the types of services provided by the customer, the number of patients served by the customer and demographic data related to the patients served by the customer.

77. The method of claim 67, wherein the customer is a hospital.

78. The method of claim 77, wherein the predicted per patient use is determined based on plural factors.

79. The method of claim 78, wherein at least one of the plural factors is drawn from the group of factors consisting of: the number of patients registered with the hospital, the number of beds in the hospital, the number of admissions in a previous time period, the number of units of drug used over a time period, and the types of procedures most often performed by the customer.

80. The method of claim 58, wherein the quantity is fixed over the time period.

81. The method of claim 58, wherein the time period is fixed.

82. The method of claim 58, wherein the fixed fee per patient in the universe is fixed over the time period.

83. The method of claim 58, further comprising providing a replenishment amount of the drug to the customer should an on-hand amount at the customer fall below a predetermined limit.

84. The method of claim 83, further comprising delivering the replenishment amount within a predetermined time period of receiving notice from the customer that the on-hand amount has fallen below the predetermined limit during the time period.

85. The method of claim 83, wherein on-hand amount at the customer is tracked and the quantity is automatically replenished should the quantity fall below a predetermined limit during the time period.

86. The method of claim 58, wherein the quantity is fixed for a duration of a first time period portion, and altered at the expiration of the first time period portion for a duration of a second time period portion.

87. The method of claim 58, wherein the time period comprises increments of time, wherein at the end of each increment of time, the quantity and/or fixed fee per patient in the universe is adjusted to mitigate financial risk.

88. The method of claim 87, wherein triggering events trigger modifications in the agreement to accommodate extraordinary circumstances.

89. The method of claim 88, wherein the triggering events are incidents that cause unexpectedly high need for the customer.

90. The method of claim 58, wherein the fixed fee per patient is fixed for the time period, then altered at the expiration of the time period for a duration of a new time period.

91. The method of claim 83, wherein the replenishment amount is limited if the needs of the customer exceed a predetermined upper need threshold.

92. The method of claim 58, wherein the fixed fee per patient in the universe is limited if the needs of the customer fail to reach a predetermined lower need threshold.

93. The method of claim 58, further comprising contracting in such a manner so as to dictate that the drug is to be used for a predetermined use.

94. The method of claim 58, further comprising contracting in such a manner so as to dictate that the drug is to be used for a predetermined universe of patients.

95. A processing system comprising an input device, a processor, an output device, a communication device and a computer-readable storage medium comprising a program for performing at least some of the method of claim 58.

96. A method for a customer to acquire a drug, the method comprising:
a. Identifying end users who potentially require the drug;
b. Determining a quantity of the drug potentially required over a time period;
c. Determining a cost to be paid to a supplier for the drug in the quantity over the time period;
d. Reaching an agreement with the supplier to purchase the drug in the quantity at the cost during the time period; and
e. As an incentive to reaching the aforementioned agreement, reaching a further agreement with the supplier in which the supplier agrees to provide an additional amount of the drug at no additional cost if such additional amount is needed within the time period.

97. The method of claim 96, wherein the drug is selected from a group consisting of: articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

98. The method of claim 96, wherein the end users are patients.

99. The method of claim 96, wherein the supplier is a manufacturer.

100. The method of claim 96, wherein the supplier is a representative of the manufacturer.

101. The method of claim 96, wherein the customer is any entity that purchases the drug.

102. The method of claim 96, wherein the customer is an entity selected from a group consisting of: doctors, pharmacies, hospitals, clinics, home health care companies, insurance companies and national health authorities.

103. The method of claim 96, wherein the quantity is determined based on plural factors.

104. The method of claim 103, wherein at least one of the plural factors is drawn from the group of factors consisting of: the type of customer, the types of services provided by the customer, the number of patients served by the customer, and demographic data related to the patients served by the customer.

105. The method of claim 102, wherein the customer is a hospital.

106. The method of claim 105, wherein the quantity is determined based on plural factors.

107. The method of claim 106, wherein at least one of the plural factors is drawn from the group consisting of: the number of beds in the hospital, the number of emergency room visits over a prior time period, the number of admissions in a previous time period, the number of units of drug used over a time period, and the types of procedures most often performed by the customer.

108. The method of claim 96, wherein the quantity is fixed over the time period.

109. The method of claim 96, wherein the time period is fixed.

110. The method of claim 96, wherein the cost is fixed over the time period.

111. The method of claim 96, wherein the supplier provides a replenishment amount of the drug to the customer should an on-hand amount at the customer fall below a predetermined limit during the time period.

112. The method of claim 111, wherein the supplier delivers the replenishment amount within a predetermined time period of receiving notice from the customer that the on-hand amount has fallen below the predetermined limit during the time period.

113. The method of claim 111, wherein the supplier tracks the on-hand amount at the customer and automatically replenishes the quantity should the quantity fall below a predetermined limit during the time period.

114. The method of claim 96, wherein the quantity is fixed for a duration of a first time period portion, and altered at the expiration of the first time period portion for a duration of a second time period portion.

115. The method of claim 96, wherein the time period comprises increments of time, wherein at the end of each increment of time, the quantity and/or cost is adjusted to mitigate financial risk.

116. The method of claim 115, wherein triggering events trigger modifications in the agreement to accommodate extraordinary circumstances.

117. The method of claim 116, wherein the triggering events are incidents that cause unexpectedly high need for the customer.

118. The method of claim 96, wherein the fixed fee per patient in the universe is fixed for the time period, then altered at the expiration of the time period for a duration of a new time period.

119. The method of claim 96, wherein the additional amount is limited if the needs of the customer exceed a predetermined upper need threshold.

120. The method of claim 96, wherein the fixed fee per patient in the universe is limited if the needs of the customer fail to reach a predetermined lower need threshold.

121. The method of claim 96, further comprising structuring the agreement so as to dictate that the drug is to be used for a predetermined use.

122. The method of claim 96, further comprising structuring the agreement so as to dictate that the drug is to be used for a predetermined universe of patients.

123. A processing system comprising an input device, a processor, an output device, a communication device and a computer-readable storage medium comprising a program for performing at least some of the method of claim 96.

124. A method for a customer to purchase a drug, the method comprising:
a. Contracting with a supplier over a time period to acquire a quantity of a drug for use by a universe of patients served by the customer based on potential patient use;
b. Paying the supplier a fixed fee per patient in the universe; and
c. Acquiring at least the quantity of the drug regardless of the quantity of the drug actually required during the time period.

125. The method of claim 124, wherein the drug is selected from a group consisting of: articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

126. The method of claim 124, wherein the supplier is a manufacturer.

127. The method of claim 124, wherein the supplier is a representative of the manufacturer.

128. The method of claim 124, wherein the customer is any entity that purchases the drug.

129. The method of claim 124, wherein the customer is an entity selected from a group consisting of: doctors, pharmacies, hospitals, clinics, home health care companies, insurance companies and national health authorities.

130. The method of claim 124, wherein the quantity is determined based on plural factors.

131. The method of claim 130, wherein at least one of the plural factors is drawn from the group consisting of: the type of customer, the types of services provided by the customer, the number of patients served by the customer, and demographic data related to the patients served by the customer.

132. The method of claim 129, wherein the customer is a hospital.

133. The method of claim 132, wherein the quantity is determined based on plural factors.

134. The method of claim 133, wherein at least one of the plural factors is drawn from the group of factors consisting of: the number of beds in the hospital, the number of emergency room visits over a prior time period, the number of admissions in a previous time period, the number of units of drug used over a time period, and the types of procedures most often performed by the customer.

135. The method of claim 124, wherein the universe of patients comprises the patients known by the customer to potentially require the drug.

136. The method of claim 124, wherein the predicted per patient use is an estimate of a patient's potential need for the drug.

137. The method of claim 124, wherein the predicted per patient use is determined based on a plural factors.

138. The method of claim 137, wherein at least one of the plural factors is drawn from the group of factors consisting of: the type of customer, the types of services provided by the customer, the number of patients served by the customer and demographic data related to the patients served by the customer.

139. The method of claim 129, wherein the customer is a hospital.

140. The method of claim 139, wherein the predicted per patient use is determined based on plural factors.

141. The method of claim 140, wherein at least one of the plural factors is drawn from the group of factors consisting of: the number of patients registered with the hospital, the number of beds in the hospital, the number of admissions in a previous time period, the number of units of drug used over a time period, and the types of procedures most often performed by the customer.

142. The method of claim 124, wherein the quantity is fixed over the time period.

143. The method of claim 124, wherein the time period is fixed.

144. The method of claim 124, wherein the fixed fee per patient in the universe is fixed over the time period.

145. The method of claim 124, wherein the supplier provides a replenishment amount of the drug to the customer should an on-hand amount at the customer fall below a predetermined limit during the time period.

146. The method of claim 145, wherein the supplier delivers the replenishment amount within a predetermined time period of receiving notice from the customer that the on-hand amount has fallen below the predetermined limit during the time period.

147. The method of claim 145, wherein the supplier tracks the on-hand amount at the customer and automatically replenishes the quantity should the quantity fall below a predetermined limit during the time period.

148. The method of claim 124, wherein the quantity is fixed for a duration of a first time period portion, and altered at the expiration of the first time period portion for a duration of a second time period portion.

149. The method of claim 124, wherein the time period comprises increments of time, wherein at the end of each increment of time, the quantity and/or fixed fee per patient is adjusted to mitigate financial risk.

150. The method of claim 149, wherein triggering events trigger modifications in the agreement to accommodate extraordinary circumstances.

151. The method of claim 150, wherein the triggering events are incidents that cause unexpectedly high need for the customer.

152. The method of claim 124, wherein the fixed fee per patient in the universe is fixed for the time period, then altered at the expiration of the time period for a duration of a new time period.

153. The method of claim 145, wherein the replenishment amount is limited if the needs of the customer exceed a predetermined upper need threshold.

154. The method of claim 124, wherein the fixed fee per patient in the universe is limited if the needs of the customer fail to reach a predetermined lower need threshold.

155. The method of claim 124, further comprising contracting in such a manner so as to dictate that the drug is to be used for a predetermined use.

156. The method of claim 124, further comprising contracting in such a manner so as to dictate that the drug is to be used for a predetermined universe of patients.

157. A processing system comprising an input device, a processor, an output device, a communication device and a computer-readable storage medium comprising a program for performing at least some of the method of claim 124.

158. A method of hemostasis management, the method comprising:
a. Contracting with a supplier over a time period to acquire a quantity of a hemostatic agent for administration to a predetermined universe of patients served by a customer based on predicted per patient use;
b. Acquiring the quantity of the hemostatic agent;
c. Paying the supplier a fixed fee per patient in the universe regardless of the amount of agent actually required by the universe of patients during the time period.

159. The method of claim 158, wherein the hemostatic agent arrests the flow of blood from an open vessel.

160. The method of claim 158, wherein the hemostatic agent is selected from the group consisting of plasma-derived hemostatic agents and recombinant hemostatic agents.

161. The method of claim 158, wherein the hemostatic agent is further selected from the group consisting of Factor VIIIa, Factor VIII, and Factor IX.

162. The method of claim 161, wherein Factor VIIa is NovoSeven®.

163. The method of claim 161, wherein Factor VIII is selected from the group consisting of Refacto®, Kogeniate FS®, Helixate FS®, Recombinate™ and Bioclate®.

164. The method of claim 161, wherein Factor IX is BeneFIX®

165. The method of claim 158, wherein the drug is selected from a group consisting of: articles recognized in the official United States Pharmacopoeia, official Homeopathic Pharmacopoeia of the United States, or official National Formulary, or any supplement to any of them; articles intended for use in the diagnosis, cure, mitigation, treatment, or prevention of disease; articles intended to affect the structure or any function of the body that are not food; and articles intended for use as a component of any article specified in the preceding three group members.

166. The method of claim 158, wherein the supplier is a manufacturer

167. The method of claim 158, wherein the supplier is a representative of the manufacturer.

168. The method of claim 158, wherein the customer is any entity that purchases the drug.

169. The method of claim 158, wherein the customer is an entity selected from a group consisting of: doctors, pharmacies, hospitals, clinics, home health care companies, insurance companies and national health authorities.

170. The method of claim 158, wherein the quantity is determined based on plural factors.

171. The method of claim 170, wherein at least one of the plural factors is drawn from a group of factors consisting of: the type of customer, the types of services provided by the customer, the number of patients served by the customer, and demographic data related to the patients served by the customer.

172. The method of claim 169, wherein the customer is a hospital.

173. The method of claim 172, wherein the quantity is determined based on plural factors.

174. The method of claim 173, wherein at least one of the plural factors is drawn from the group of factors consisting of: the number of beds in the hospital, the number of emergency room visits over a prior time period, the number of admissions in a previous time period, the number of units of drug used over a time period, and the types of procedures most often performed by the customer.

175. The method of claim 158, wherein the predetermined universe of patients comprises the patients known by the customer to potentially require the drug.

176. The method of claim 158, wherein the predicted per patient use is an estimate of a patient's potential need for the drug.

177. The method of claim 158, wherein the predicted per patient use is determined based on plural factors.

178. The method of claim 177, wherein at least one of the plural factors is drawn from the group of factors consisting of: the type of customer, the types of services provided by the customer, the number of patients served by the customer and demographic data related to the patients served by the customer.

179. The method of claim 169, wherein the customer is a hospital.

180. The method of claim 179, wherein the predicted per patient use is determined based on plural factors.

181. The method of claim 180, wherein at least one of the plural factors is drawn from the group of factors consisting of: the number of patients registered with the hospital, the number of beds in the hospital, the number of admissions in a previous time period, the number of units of drug used over a time period, and the types of procedures most often performed by the customer.

182. The method of claim 158, wherein the quantity is fixed over the time period.

183. The method of claim 158, wherein the time period is fixed.

184. The method of claim 158, wherein the fixed fee per patient in the universe is fixed over the time period.

185. The method of claim 158, wherein the supplier provides a replenishment amount of the drug to the customer should an on-hand amount at the customer fall below a predetermined limit during the time period.

186. The method of claim 185, wherein the supplier delivers the replenishment amount within a predetermined time period of receiving notice from the customer that the on-hand amount has fallen below the predetermined limit during the time period.

187. The method of claim 185, wherein the supplier tracks the on-hand amount at the customer and automatically replenishes the quantity should the quantity fall below a predetermined limit during the time period.

188. The method of claim 158, wherein the quantity is fixed for a duration of a first time period portion, and altered at the expiration of the first time period portion for a duration of a second time period portion.

189. The method of claim 158, wherein the time period comprises increments of time, wherein at the end of each increment of time, the quantity and/or fixed fee per patient in the universe is adjusted to mitigate financial risk.

190. The method of claim 189, wherein triggering events trigger modifications in the agreement to accommodate extraordinary circumstances.

191. The method of claim 190, wherein the triggering events are incidents that cause unexpectedly high need for the customer.

192. The method of claim 158, wherein the fixed fee per patient in the universe is fixed for the time period, then altered at the expiration of the time period for a duration of a new time period.

193. The method of claim 185, wherein the replenishment amount is limited if the needs of the customer exceed a predetermined upper need threshold.

194. The method of claim 158, wherein the fixed fee per patient in the universe is limited if the needs of the customer fail to reach a predetermined lower need threshold.

195. The method of claim 158, further comprising contracting in such a manner so as to dictate that the drug is to be used for a predetermined use.

196. The method of claim 158, further comprising contracting in such a manner so as to dictate that the drug is to be used for a predetermined universe of patients.

197. A processing system comprising an input device, a processor, an output device, a communication device and a computer-readable storage medium comprising a program for performing at least some of the method of claim 158.
